(19) United States
(12) Patent Application Publication
(10) Pub. No.: US 2017/0228131 A1
(43) Pub. Date: Aug. 10, 2017

(54) MOBILE TERMINAL AND METHOD FOR CONTROLLING THE SAME

(71) Applicant: LG ELECTRONICS INC., Seoul (KR)

(72) Inventors: Kayalvizhi PANDIARAJ, Bangalore (IN); Venu Ram Rajkumar NEELAM, Bangalore (IN); Bellappa Gouda PATIL, Bangalore (IN); Sachin Kumar LINGESWARA, Bangalore (IN)

(73) Assignee: LG ELECTRONICS INC., Seoul (KR)

(21) Appl. No.: 15/329,028

(22) PCT Filed: Jan. 5, 2015
(86) PCT No.: PCT/KR2015/000052

§ 371 Date: Jan. 25, 2017

(30) Foreign Application Priority Data
Aug. 21, 2014 (KR) 10-2014-0109112

(51) Int. Cl. G06F 3/0481; G06F 3/0482; G06F 3/0488

(52) U.S. Cl. CPC G06F 3/04817; G06F 3/0488; G06F 3/0482; G06F 2203/04808

(57) ABSTRACT

The present disclosure relates to a mobile terminal outputting widgets and a control method thereof. A mobile terminal according to one embodiment disclosed herein includes a display unit to output an icon corresponding to an application, and receive a touch input applied to the icon to output a widget associated with the application, and a controller to detect at least one widget corresponding to the application as the widget associated with the application, in response to the touch input, detect at least one widget as the widget associated with the application, in response to the touch input, the at least one widget being detected based on an event generated within a preset time before and after activation of the application and an event generated within a preset time before the touch input is applied, and control the display unit to output the detected at least one widget.

### TECHNICAL FIELD

The present disclosure relates to a mobile terminal which outputs a widget and a control method thereof.

### BACKGROUND ART

Terminals may be divided into mobile/portable terminals and stationary terminals according to their mobility. Also, the mobile terminals may be classified into handheld terminals and vehicle mount terminals according to whether or not a user can directly carry.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. Specifically, in recent time, mobile terminals can receive broadcast and multicast signals to allow viewing of video or television programs.

As it becomes multifunctional, a mobile terminal can be allowed to capture still images or moving images, play music or video files, play games, receive broadcast and the like, so as to be implemented as an integrated multimedia player.

Accordingly, a widget as a set of tools, which are collected for activating specific functions immediately on a screen, may be executed on a terminal. For example, a set of service tools that functions such as weather, calendar, schedule, clock, notice and the like are collected at one side of a home screen to be immediately checked may be executed.

However, due to the shortage of functions for managing the widgets in an integrating manner, widgets should be managed individually.

Further, a user is allowed to arrange a plurality of widgets corresponding to a specific application on a plurality of home screen pages, respectively. Accordingly, in order for the user to use one of the plurality of widgets corresponding to the specific application, the user has to search for a desired widget by flicking the plurality of home screen pages.

### DISCLOSURE OF INVENTION

### Technical Problem

Therefore, an aspect of the detailed description is to overcome the aforementioned problems and other disadvantages. Another aspect of the detailed description is to provide a mobile terminal, capable of integrally managing widgets associated with an application, and a control method thereof.

### Solution to Problem

To achieve these and other advantages and in accordance with the purpose of the present invention, as embodied and broadly described herein, there is provided a mobile terminal including a display unit that is configured to output an icon corresponding to an application, and receive a touch input applied to the icon to output a widget associated with the application, and a controller. The controller may be configured to detect at least one widget corresponding to the application as the widget associated with the application, in response to the touch input, detect at least one widget as the widget associated with the application, in response to the touch input. Here, the at least one widget may be detected based on an event generated within a preset time before and after activation of the application and an event generated within a preset time before the touch input is applied. The controller may also be configured to control the display unit to output the detected at least one widget associated with the application.

In one embodiment disclosed herein, the controller may detect at least one widget, which is detected based on the number of times that a widget is executed within a preset time before and after the activation of the application, as the widget associated with the application.

In one embodiment disclosed herein, the controller may detect a widget preset to correspond to a second application as the widget associated with the application when the second application, different from the application, is executed within a preset time before the touch input is applied.

In one embodiment disclosed herein, the controller may detect at least one widget preset to correspond to the application as the widget associated with the application.

In one embodiment disclosed herein, the controller may control the display unit to sequentially output the detected at least one widget associated with the application according to a preset criterion.

In one embodiment disclosed herein, the controller may control the display unit to delete one of the output at least one widget associated with the application, in response to a user's input.

In one embodiment disclosed herein, the controller may control the display unit to add a newly-selected widget to the widget associated with the application for output, in response to a user's input for selecting the new widget.

In one embodiment disclosed herein, the controller may control the display unit to set a size of a region on which the widget associated with the application is output, in response to a user's input.

In one embodiment disclosed herein, the controller may control the display unit to set an output position of the widget associated with the application, in response to a user's input.

In one embodiment disclosed herein, the controller may control the display unit to output the widget associated with the application, in response to a preset touch input applied to an execution screen of the application.

To achieve these and other advantages and in accordance with the purpose of the present invention, as embodied and broadly described herein, there is provided a control method for a mobile terminal, the method including (a) outputting an icon corresponding to an application, (b) receiving a touch input applied to the icon to output a widget associated with the application, (c1) detecting at least one widget corresponding to the application as the widget associated with the application, in response to the touch input, (c2) detecting at least one widget, which is detected based on an event generated within a preset time before and after activation of the application and an event generated within a preset time before the touch input is applied, as the widget associated with the application, in response to the touch input, and (d) outputting the detected at least one widget associated with the application.

In one embodiment disclosed herein, the step (c2) may include detecting at least one widget, which is detected based on the number of times that a widget is executed within a preset time before and after the activation of the application, as the widget associated with the application.

In one embodiment disclosed herein, the step (c2) may include detecting a widget preset to correspond to a second application as the widget associated with the application when the second application, different from the application, is executed within a preset time before the touch input is applied.

In one embodiment disclosed herein, the step (c2) may include detecting at least one widget preset to correspond to the application as the widget associated with the application.

In one embodiment disclosed herein, the step (d) may include sequentially outputting the detected at least one widget associated with the application according to a preset criterion.

In one embodiment disclosed herein, the step (d) may include deleting one of the output at least one widget associated with the application, in response to a user's input.

In one embodiment disclosed herein, the step (d) may include adding a newly-selected widget to the widget associated with the application for output, in response to a user's input for selecting the new widget.

In one embodiment disclosed herein, the step (d) may include setting a size of a region on which the widget associated with the application is output, in response to a user's input.

In one embodiment disclosed herein, the step (d) may include setting an output position of the widget associated with the application, in response to a user's input.

In one embodiment disclosed herein, the step (d) may include outputting the widget associated with the application, in response to a preset touch input applied to an execution screen of the application.

### Advantageous Effects of Invention

According to at least one embodiment of the present disclosure, it can be possible to overcome inconvenience in that a desired widget should be searched for by applying a flicking input to home screen pages in order to use one of a plurality of widgets corresponding to a specific application.

Also, according to at least one embodiment of the present disclosure, widgets associated with an application can be integrally managed and an output state of each widget can be edited in an easy manner.

These may result in enhancement of user's convenience.

### BRIEF DESCRIPTION OF DRAWINGS

FIG. 1A is a block diagram of a mobile terminal in accordance with the present disclosure.

FIGS. 1B and 1C are conceptual views illustrating one example of the mobile terminal, viewed from different directions.

FIG. 2A is a flowchart illustrating a control method for a mobile terminal in accordance with one exemplary embodiment disclosed herein.

FIG. 2B is a conceptual view illustrating an embodiment of a user interface through which a widget (or at least one widget) associated with an application are output.

FIGS. 3A to 3D are conceptual views illustrating other embodiments of a user interface through which a widget (or at least one widget) associated with an application are output.

FIG. 3E is a conceptual view illustrating an embodiment of a user interface for presetting a widget (or at least one widget) associated with an application.

FIG. 4 is a conceptual view illustrating an embodiment of a user interface for deleting a widget output in association with an application.

FIG. 5 is a conceptual view illustrating an embodiment of a user interface for adding a widget associated with an application.

FIG. 6 is a conceptual view illustrating an embodiment of a user interface for adjusting a size of a region for outputting therein a widget associated with an application.

FIG. 7 is a conceptual view illustrating an embodiment of a user interface for rearranging widgets associated with an application.

FIG. 8 is a conceptual view illustrating another embodiment of a user interface for sequentially outputting widgets associated with an application.

FIG. 9 is a conceptual view illustrating an embodiment of a user interface for shifting an application and a widget.

### MODE FOR THE INVENTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, moreover, the detailed description will be omitted when a specific description for publicly known technologies to which the invention pertains is judged to obscure the gist of the present disclosure. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

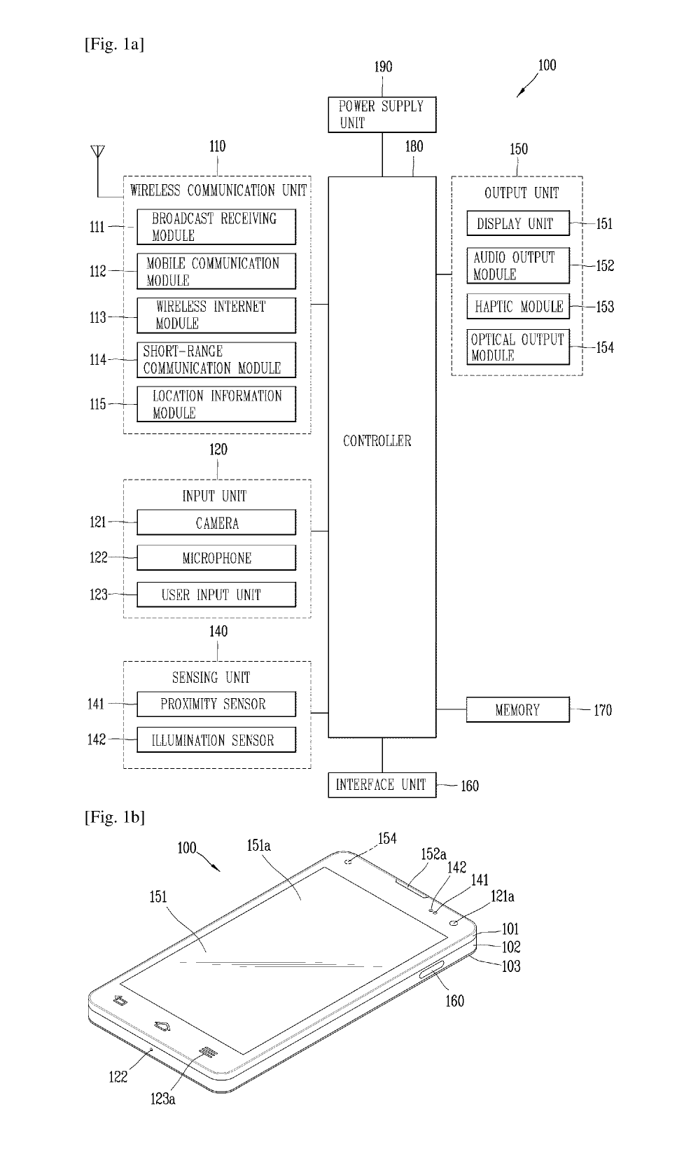

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 may be shown having components such as a wireless communication unit 110, an input unit 120, a sensing unit 140, an output unit 150, an interface unit 160, a memory 170, a controller 180, and a power supply unit 190. It may be understood that implementing all of the illustrated components is not a requirement, and that greater or fewer components may alternatively be implemented.

In more detail, the wireless communication unit 110 among those components may include one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 may include one or more modules which connect the mobile terminal 100 to one or more networks.

The wireless communication unit 110 may include one or more of a broadcast receiving module 111, a mobile communication module 112, a wireless Internet module 113, a short-range communication module 114, and a location information module 115.

The input unit 120 may include a camera 121 or an image input unit for inputting an image signal, a microphone 122 or an audio input unit for inputting an audio signal, and a user input unit 123 (for example, a touch key, a push key, and the like) for allowing a user to input information. Data (for example, audio, video, image, and the like) is obtained by the input unit 120 and may be analyzed and processed according to user commands.

The sensing unit 140 may be implemented using one or more sensors configured to sense internal information of the mobile terminal, the surrounding environment of the mobile terminal, user information, and the like. For example, the sensing unit 140 is shown having a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 may be configured to output various types of information, such as audio, video, tactile output, and the like. The output unit 150 may be shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170.

As one example, the controller 180 controls some or all of the components illustrated in FIG. 1A according to the execution of an application program that have been stored in the memory 170. Also, the controller 180 may operate at least two components included in the mobile terminal in a combining manner to activate the application program.

The power supply unit 190 can be configured to receive external power or provide internal power, under the control of the controller, in order to supply appropriate power required for operating elements and components included in the mobile terminal 100. The power supply unit 190 may include a battery, and the battery may be configured to be embedded in the terminal body, or configured to be detachable from the terminal body.

At least some of those components may be combined for operation to implement an operation, a control or a control method of the mobile terminal according to various embodiments disclosed herein. Also, the operation, the control or the control method of the mobile terminal may be implemented on the mobile terminal by activating at least one application program stored in the memory 170.

Hereinafter, prior to describing various exemplary embodiments implemented by the mobile terminal 100, each of the aforementioned components will be described in more detail with reference to FIG. 1A.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000(Code Division Multi Access 2000), Enhanced VoiceDate Optimized or Enhanced Voice-Data Only (EV-DO), Wideband CDMA (WCDMA), High Speed Downlink Packet access (HSDPA), High Speed Uplink Packet Access (HSUPA), Long Term Evolution (LTE), LTE-advanced (LTE-A) and the like).

Examples of the wireless signals include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), LTE-advanced (LTE-A) and the like. The wireless Internet module 113 may transmit/receive data according to one or more of such wireless Internet technologies, and other Internet technologies as well.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications may include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module. If necessary, the location information module 115 may perform a function of another module of the wireless communication unit 110, in order to obtain data associated with a location of the mobile terminal in a replacing manner or an additional manner. The location information module 115 is a module used for acquiring a location (or a current location) of the mobile terminal, and may not be limited to a module which directly calculates or acquires the location of the mobile terminal.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 processes an external audio signal into electric audio data. The processed audio data may be utilized in various manners according to a currently-executed function (or a currently-executed application program) in the mobile terminal 100. Meanwhile, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element or a mechanical key (for example, a button located on a front and/or rear surface or a side surface of the mobile terminal 100, a dome switch, a jog wheel, a jog switch, and the like), or a touch-sensitive input element, among others. As one example, the touch-sensitive input element may be a virtual key, a soft key or a visual key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 refers to a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch (or touch input) applied to the touch screen, such as the display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

The camera 121 as a component of the input unit 120 typically includes at least one of a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160, for example, may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

Here, regarding the mobile terminal 100 as at least one assembly (or set), the terminal body may be understood as a conception referring to the assembly (or the set).

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a unibody is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 is shown having a display unit 151, first and second audio output modules 152a and 152b, a proximity sensor 141, an illumination sensor 142, an optical output module 154, first and second cameras 121a and 121b, first and second manipulation units 123a, 123b, a microphone 122, an interface unit 160, and the like.

Hereinafter, description will be given, as illustrated in FIGS. 1B and 1C, of an exemplary embodiment of a mobile terminal, in which the display unit 151, the first audio output module 152a, the proximity sensor 141, the illumination sensor 142, the optical output module 154, the first camera 121a and the first manipulation units 123a are disposed on a front surface of a terminal body, the second manipulation unit 123b, the microphone 122 and the interface unit 160 are disposed on a side surface of the terminal body, and the second audio output module 152b and the second camera 121b are disposed on a rear surface of the terminal body.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a receiver to transfer voice audio to a user's ear, and the second audio output module 152b may be implemented in the form of a loud speaker to output alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

The drawings illustrate an example that the first manipulation unit 123a is a touch key, but the present disclosure may not be limited to this. For example, the first manipulation unit 123a may be configured as a push key (or a mechanical key) or in combination of the touch key and the push key.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

A flash 124 is shown adjacent to the second camera 121b. When an image of a subject is captured with the camera 121b, the flash 124 may illuminate the subject.

The second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Hereinafter, embodiments associated with a control method which can be implemented in the mobile terminal having such configuration will be described with reference to the accompanying drawings. It is obvious to those skilled in the art that the present disclosure can be specified into other particular forms without departing from the spirit and essential features of the present disclosure.

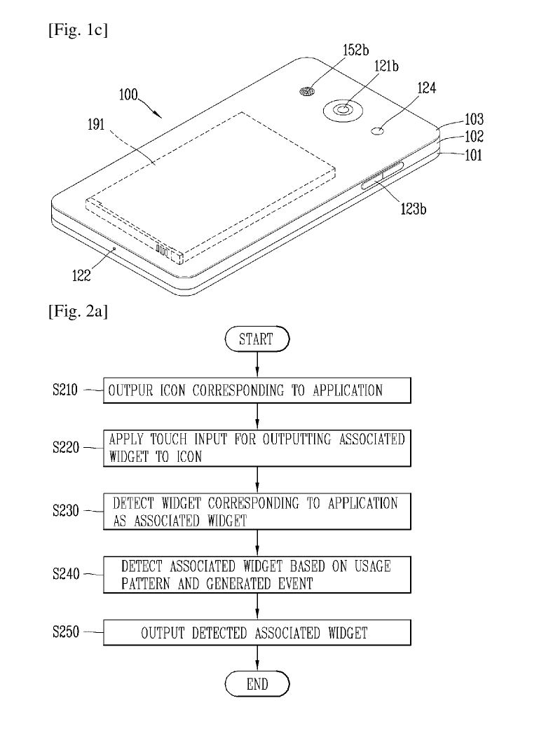

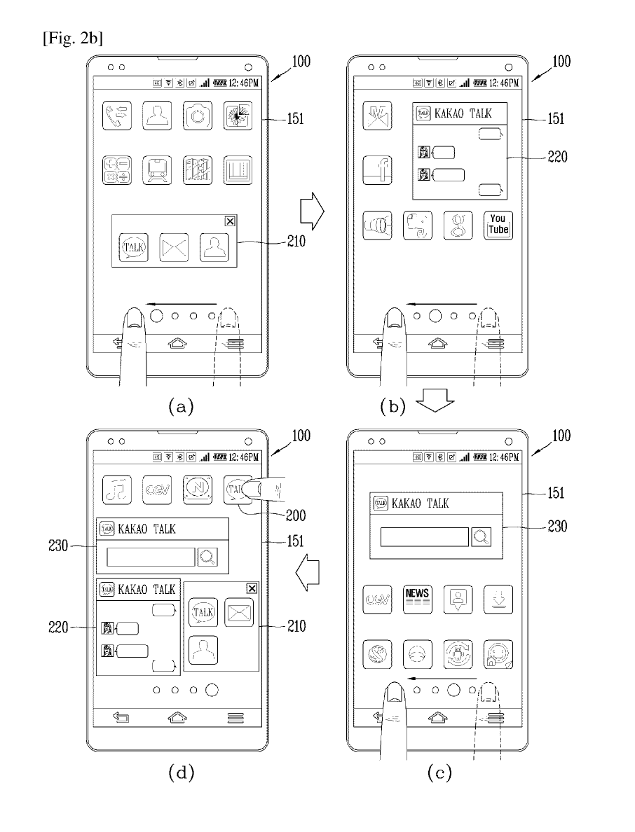

FIG. 2A is a flowchart illustrating a control method for a mobile terminal in accordance with one exemplary embodiment disclosed herein.

As illustrated in FIG. 2A, an icon corresponding to an application is output on the display unit 151 (S210).

In detail, the icon corresponding to the application refers to a graphic object which is output on the display unit 151 to execute a function of the application. For example, when the icon is selected, the application corresponding to the icon may be executed.

Afterwards, a touch input for outputting widgets associated with the application is applied to the icon (S220).

In detail, the widgets refer to a set of tools in which only specific functions are collected to be used on the screen 151 as soon as being desired. For example, the widgets correspond to a set of service tools, in which several functions such as memo, weather, calendar, schedule, clock, notice and the like are collected at one side of the home screen 151 to be visible at once.

For example, widgets corresponding to a specific application may be stored in the memory 170 when the terminal 100 is fabricated, or downloaded along with the specific application when the specific application is downloaded.

Also, one application may have various forms and types of widgets, and those widgets may show some of information which is output while the specific application is activated.

Meanwhile, the touch input for outputting the widgets associated with the application may be implemented in various inputting manners with respect to the icon output on the touch screen 151.

For example, the touch input for outputting the widgets associated with the application may be implemented as a long touch input or a double tap input applied to the icon.

Here, the touch input for outputting the widgets associated with the application may be distinguished over a touch input for executing the application. Or, when the touch input for outputting the widgets associated with the application is applied, the application may be executed and simultaneously the associated widgets may be output.

For example, when a long touch input is applied to the icon, the widgets associated with the application may be output. When a short touch input is applied to the icon, the application may be activated.

As another example, when a double tap input is applied to the icon, the application may be activated and the widgets associated with the application may be output along with the application which is being executed.

Then, in response to the touch input for outputting the widget associated with the application, at least one widget associated with the application is detected as the widget associated with the application (S230).

For example, when a touch input for outputting the widget associated with the application is applied to an icon corresponding to a messenger application, at least one widget corresponding to the messenger application may be detected as the widget associated with the application.

This may allow for overcoming inconvenience, which results from having to search for a desired widget by applying a flicking touch to the home screen page, in order to use one of a plurality of widgets corresponding to the messenger application.

Also, in response to the touch input for outputting the widget associated with the application, at least one widget, which is detected based on an event generated within a preset time before and after an execution of the application and an event generated within a preset time before the touch input is applied, is detected as the widget associated with the application (S240).

In detail, an event which is generated within a preset time before and after an execution of an application may include a user's usage pattern which relates to the execution of the application.

For example, when a pattern of executing a first widget after activating a first application has frequently been detected, the first widget may be detected as a widget associated with the first application.

Also, an event which is generated within a preset time before a touch input for outputting at least one widget associated with a specific application is applied may include an execution of an application different from the specific application.

In detail, when a second application different from a specific application is executed, a widget which has been preset to correspond to the second application may be detected as the widget associated with the specific application.

For example, when the second application is activated before a touch input for outputting the widget associated with the first application is applied, a widget including the second application or a widget preset to correspond to the second application may be detected as the widget associated with the first application.

As another example, the second application different from the first application may be a widget preset to correspond to the first application.

In detail, when the second application and a third application are activated before a touch input for outputting the widget associated with the first application is applied, only an event that the second application is activated may be considered.

Accordingly, a widget including the second application or a widget preset to correspond to the second application may be detected as the widget associated with the first application.

Meanwhile, the detected at least one widget may be a widget preset by a user on the screen 151, or a new widget recommended by the terminal 100.

Also, as one example, the steps S230 and S240 may be executed in the reverse order. That is, in response to the touch input for outputting the widget associated with the application, a widget which takes an event into account may be detected and thereafter the widget corresponding to the application may be detected.

Next, the detected at least one widget associated with the application is output (S250). In detail, a plurality of widgets detected may be output in a simultaneous manner or a sequential manner based on a preset criterion.

Also, sizes and positions of regions where widgets associated with an application are output may be set randomly or by a user.

For example, the sizes and positions of the regions for outputting the widgets may be adjustable, taking into account the number of widgets to be output, so as to prevent overlapping of the widgets-output regions or minimize the overlapped regions.

That is, even though a widget is output on the home screen 151, the widget may be newly adjusted in size for output, irrespective of a size of a region in which the widget is output on the home screen 151.

Also, data which is visible in real time may be output on a widget which is output. For example, when a widget including an SNS application is output, postings updated in real time may be output on the corresponding widget.

Here, the user may edit the widget being output. For example, one of widgets output may be deleted or a new widget may be added as a widget associated with an application, in response to a user input.

As another example, a size or position of a region for outputting therein a widget associated with an application may be adjustable in response to a user input.

Meanwhile, as aforementioned, the user may arrange a plurality of widgets corresponding to a specific application on a plurality of home screen pages, respectively. In this case, in order to search for the plurality of widgets corresponding to the specific application, the user has to turn over the home screen pages by flicking the home screen pages and check the widgets corresponding to the specific application, which causes inconvenience in use. On the other hand, the present disclosure can overcome such inconvenience by use of a simply-applied touch input.

FIG. 2B is a conceptual view illustrating an embodiment of a user interface through which a widget (or at least one widget) associated with an application are output.

As illustrated in (a) of FIG. 2B, a first widget 210 corresponding to a messenger application may be provided on a first page of the home screen 151. A user may then turn over pages of the home screen 151 through a flicking input.

As illustrated in (b) of FIG. 2B, a second widget 220 which is another widget corresponding to the messenger application may be provided on a second page of the home screen. Similarly, the user may turn over the pages of the home screen through the flicking input.

As illustrated in (c) of FIG. 2B, a third widget 230 which is another widget corresponding to the messenger application may be provided on a third page of the home screen. Similarly, the user may turn over the pages of the home screen through the flicking input.

As illustrated in (d) of FIG. 2B, an icon 200 corresponding to the messenger application may be output on a fourth page of the home screen. Accordingly, the user may apply a touch input for outputting widgets associated with the messenger application to the icon 200. For example, the user may apply a long touch input or a double tap input to the icon 200.

In response to the user's touch input, the widgets 210, 220 and 230 which are provided on the pages of the home screen, respectively, may be output as the widgets associated with the messenger application.

For example, the widgets 210, 220 and 230 may be output adjacent to the icon 200 corresponding to the messenger application or sequentially output according to a preset order. That is, the first widget 210 may first be output and then the second widget 220 may be output.

Meanwhile, as aforementioned, the controller 180 may detect at least one widget, which is detected based on the number of execution of widgets within a preset time before and after an execution of an application, as the widget associated with the application.

Also, when a second application, which is different from an application, is activated within a preset time before a touch input for outputting the widget associated with the application is applied, a preset widget corresponding to the second application may be detected as the widget associated with the application.

As another example, the controller 180 may detect at least one widget which is preset in correspondence to an application may be detected as a widgets associated with the application.

Here, the controller 180 may control the display unit 151 to sequentially output the at least one widget associated with the application based on a preset criterion.

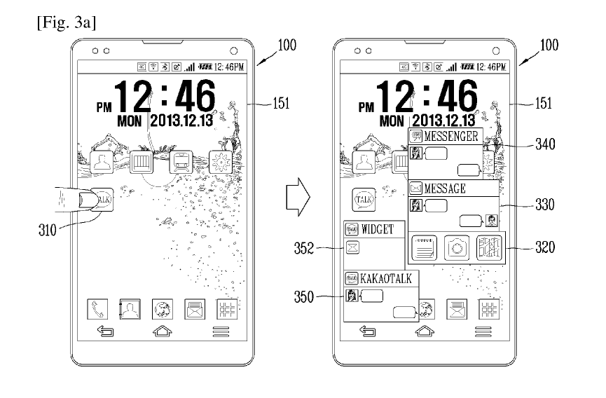

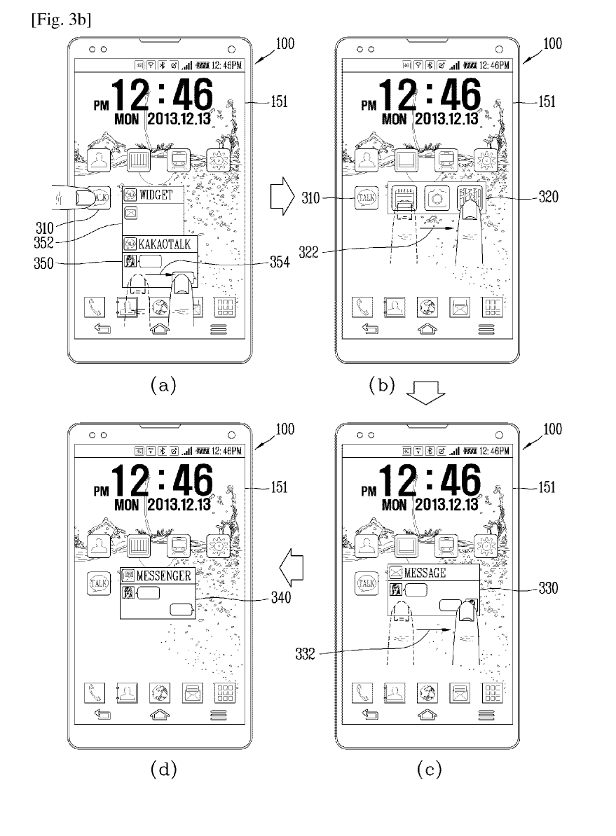

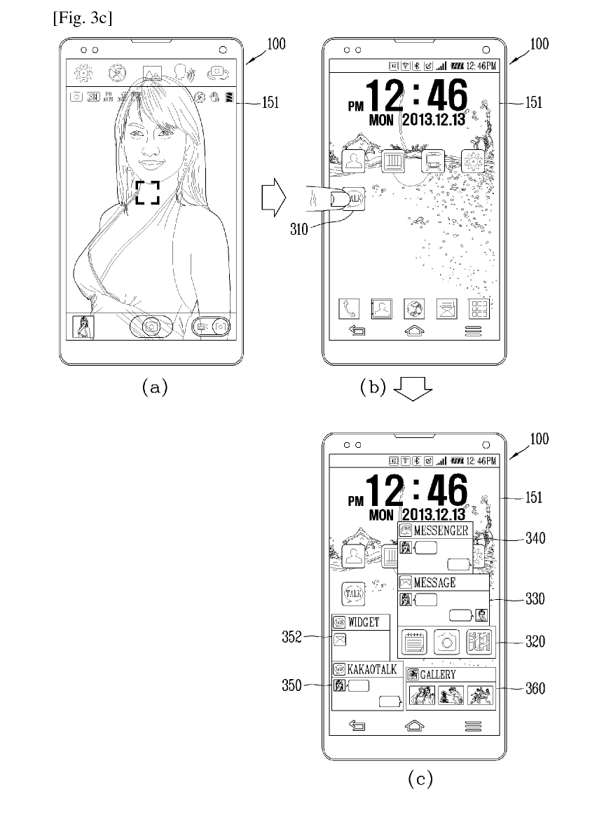

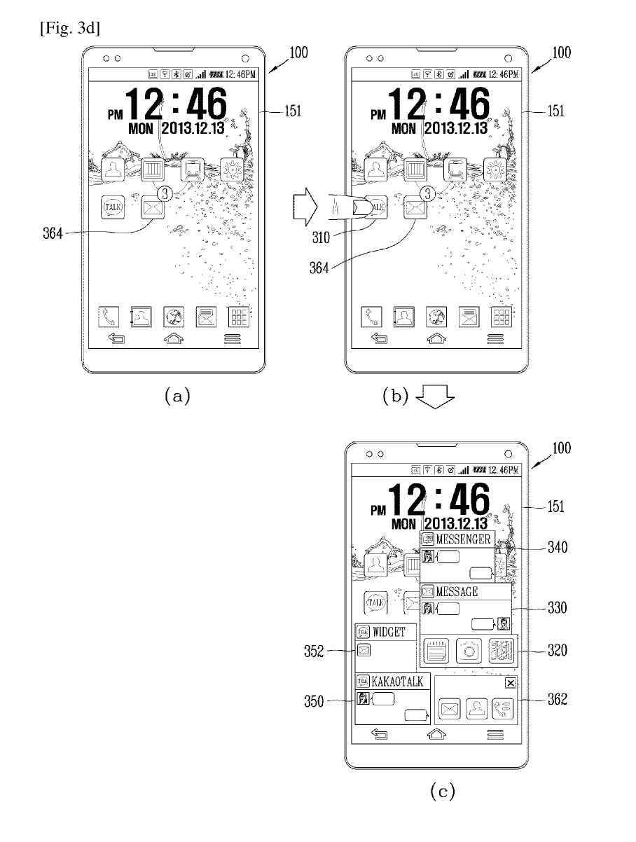

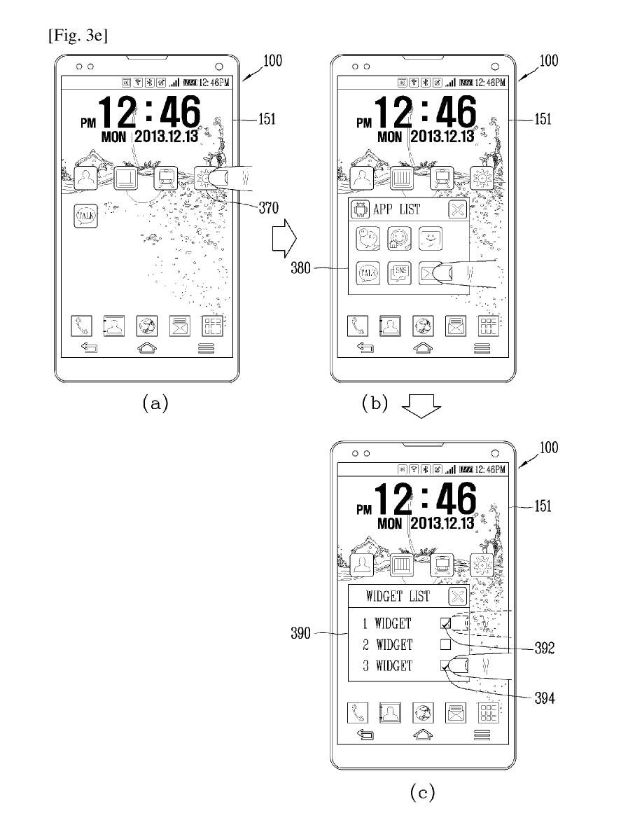

FIGS. 3A to 3D are conceptual views illustrating other embodiments of a user interface through which a widget (or at least one widget) associated with an application are output.

As illustrated in (a) of FIG. 3A, a user may select an icon 310, which corresponds to a first messenger application output on the screen 151, in a manner of applying a long touch.

As illustrated in (b) of FIG. 3A, in response to the user's long touch, widgets 320, 330, 340, 350 and 352 associated with the first messenger application may be output.

In detail, widgets 350 and 352 corresponding to the first messenger application, a first widget 320 corresponding to a camera application, a second widget 330 corresponding to a second messenger application, and a third widget 340 corresponding to a third messenger application may be output as the widgets associated with the first messenger application.

Here, sizes and positions of regions for outputting the widgets 320, 330, 340, 350 and 352 associated with the first messenger application may be randomly set or set by the user.

For example, the sizes and positions of the regions for outputting the widgets 320, 330, 340, 350 and 352 may be adjustable such that an overlap of the regions for outputting the widgets 320, 330, 340, 350 and 352 can be prevented or minimized, taking into account the number of widgets output.

That is, although the widgets have already been output on the home screen 151, the sizes of the regions for outputting the widgets may be newly adjustable, irrespectively of the sizes of the regions where the widgets have already been output on the home screen.

Meanwhile, the controller 180 may detect the widgets 350 and 352 corresponding to the first messenger application may be detected as the widgets associated with the first messenger application.

This may solve the user's inconvenience, resulting from having to search for a desired widget by applying a flicking input to the home screen page to use one of the plurality of widgets 350 and 352 corresponding to the first messenger application.

Also, the controller 180 may detect the widgets 320, 330 and 340 associated with the first messenger application based on an event generated within a preset time before and after activation of the first messenger application.

In detail, the controller 180 may detect the widgets 320, 330 and 340 associated with the first messenger application, based on a user's usage pattern relating to the activation of the first messenger application.

For example, when the number of activating the camera application prior to activating the first messenger application is more than a preset number of times, the first widget 320 corresponding to the camera application may be detected as the widget associated with the first messenger application.

When the number of activating the second messenger application and the third messenger application after activating the first messenger application is more than a preset number of times, the second widget 320 corresponding to the second messenger application and the third widget 340 corresponding to the third messenger application may be detected as the widgets associated with the first messenger application.

As another example, the widgets associated with the first messenger application may be preset. The widgets may be set by the user, or automatically set in the terminal 100.

That is, the user may preset the widgets 350 and 352 corresponding to the first messenger application, the first widget 320 corresponding to the camera application, the second widget 330 corresponding to the second messenger application, and the third widget 340 corresponding to the third messenger application to be output as the widgets associated with the first messenger application.

Also, it may be automatically set in the terminal such that the widgets 350 and 352 corresponding to the first messenger application, the first widget 320 corresponding to the camera application, the second widget 330 corresponding to the second messenger application, and the third widget 340 corresponding to the third messenger application can be output as the widgets associated with the first messenger application.

As another example, the controller 180 may detect a widget, which is detected based on a user's usage pattern relating to the activation of the first messenger application, and a widget, which is preset to be output as the widget associated with the first messenger application, as the widgets associated with the first messenger application.

For example, the controller 180 may detect, as the widgets associated with the first messenger application, the first widget 320 which is preset by the user as the widget associated with the first messenger application, and the second widget 330 corresponding to the second messenger application which has been activated more than a preset number of times after activating the first messenger application.

Meanwhile, the detected widgets 320, 330, 340, 350 and 352 may be preset by the user on the home screen 151 or newly recommended by the terminal 100.

Meanwhile, as aforementioned, the controller 180 may control the display unit 151 to sequentially output the detected widgets associated with the application according to the preset criterion.

As illustrated in (a) of FIG. 3B, the user may select the icon 310, which corresponds to the first messenger application and is output on the screen 151, in a touching manner.

The widgets 350 and 352 corresponding to the first messenger application may be output, in response to a user's touch input. Afterwards, the user may apply a flicking input 354 onto the screen on which the widgets 350 and 352 corresponding to the first messenger application are output.

As illustrated in (b) of FIG. 3B, in response to the flicking input 354, the first widget 320 corresponding to the camera application may be output. Afterwards, the user may apply a flicking input 322 onto the screen on which the first widget 320 is output.

As illustrated in (c) of FIG. 3B, in response to the user's flicking input 322, the second widget 330 corresponding to the second messenger application may be output. Similarly, the user may apply a flicking input 332 onto the screen on which the second widget 330 is output.

As illustrated in (d) of FIG. 3B, in response to the user's flicking input 332, the third widget 340 corresponding to the third messenger application may be output.

That is, the widgets 320, 330, 340, 350 and 352 associated with the first messenger application may be output simultaneously as illustrated in FIG. 3A or output sequentially according to a preset criterion as illustrated in FIG. 3B.

In detail, the controller 180 may detect the widgets 350 and 352 corresponding to the first messenger application as the widgets associated with the first messenger application. This may allow the user to avoid inconvenience, resulting from having to search for a desired widget by applying a flicking input to the home screen page to use one of the plurality of widgets 350 and 352 corresponding to the first messenger application.

Also, the controller 180 may detect the widgets 320, 330 and 340 associated with the first messenger application, based on an event generated within a preset time before and after activation of the first messenger application.

That is, the controller 180 may detect the widgets 320, 330 and 340 associated with the first messenger application, based on a user's usage pattern relating to the activation of the first messenger application.

For example, the first widget 320 corresponding to the camera application, the second widget 330 corresponding to the second messenger application and the third widget 340 corresponding to the third messenger application may be detected as widgets which have been activated more than a preset number of times before and after activating the first messenger application.

Here, the detected widgets 320, 330 and 340 may be output according to the order of the number of activations.

That is, the first widget 320 corresponding to the camera application which has been activated the greatest number of times before activating the first messenger application may be output first, followed by the second widget 330 corresponding to the second messenger application, which has been activated the next greatest number of times after activating the first messenger application, by the user's flicking input 322.

Similarly, the third widget 340 corresponding to the third messenger application which has been activated the least number of times after activating the first messenger application may be output sequentially in response to the user's flicking input 332.

As another example, types of widgets associated with an application and an output order of the associated widgets may be preset. The types of widgets and the output order of the widgets may be set by the user or automatically set in the terminal 100.

In detail, the user may preset the widgets 350 and 352 corresponding to the first messenger application, the first widget 320 corresponding to the camera application, the second widget 330 corresponding to the second messenger application, and the third widget 340 corresponding to the third messenger application to be sequentially output as the widgets associated with the first messenger application.

Also, the widgets 350 and 352 corresponding to the first messenger application, the first widget 320 corresponding to the camera application, the second widget 330 corresponding to the second messenger application, and the third widget 340 corresponding to the third messenger application may be preset in the terminal 100 to be sequentially output as the widgets associated with the first messenger application.

As another example, the widgets 320, 330, 340, 350 and 352 associated with the first messenger application may be sequentially output even without the user inputs 354, 322 and 332.

In detail, after the first widget 320 is output for a predetermined time, the second widget 330 may be sequentially output. Or, when a control command has not been input by the user for the predetermined time that the first widget 320 is output, the second widget 330 may then be output.

As aforementioned, the controller 180 may detect at least one widget, which is detected based on an event generated within a preset time before receiving a touch input for outputting a widget associated with an application, as the widget associated with the application.

In detail, when a second application which is different from an application is executed within a preset time before receiving a touch input for outputting widgets associated with the application, a preset widget to correspond to the second application may be detected as the widget associated with the application.

As illustrated in (a) of FIG. 3C, a user may capture an image using the camera application.

As illustrated in (b) of FIG. 3C, after capturing the image, the user may apply a touch input to the icon 310 to output widgets associated with the first messenger application.

As illustrated in (c) of FIG. 3C, according to the examples illustrated in FIGS. 3A and 3B, the widgets 350 and 352 corresponding to the first messenger application, the first widget 320, the second widget 330 and the third widget 340 may be detected and output as the widgets associated with the first messenger application.

Also, when the touch input for outputting the widgets associated with the first messenger application is applied to the icon 310, a fourth widget 360 corresponding to a gallery application may be output. Here, the fourth widget 360 refers to a preset widget to be output when the camera application has previously been executed.

In detail, the camera application which is the application corresponding to the first messenger application may be preset by a user or by the terminal 100.

Similarly, the fourth widget 360 corresponding to the gallery application may be preset by the user or by the terminal 100 to be output when the camera application has previously been executed.

Accordingly, when the camera application has been executed (capturing event) before receiving the touch input applied to the icon 310 of the first messenger application for detecting the associated widgets, the preset fourth widget 360 may be output along with those detected widgets 320, 330, 340, 350 and 352.

As another example, referring to (a) of FIG. 3D, a message may be received before a touch input for outputting the widgets associated with the first messenger application is applied to the icon 310.

In detail, an icon 364 of a message application indicating that three messages have been received may be output.

As illustrated in (b) of FIG. 3D, the user may apply a touch input for outputting the widgets associated with the first messenger application to the icon 310 after the generation of the message reception event.

As illustrated in (c) of FIG. 3D, a preset fifth widget 362 corresponding to the message application (message reception event) may be output along with the detected widgets 320, 330, 340, 350 and 352. Here, the fifth widget 362 may be a widget corresponding to the message application.

That is, the widgets associated with the application may be detected, taking into account an event which is generated before a touch input for detecting the widgets associated with the application is applied.

As aforementioned, the generated event may be an event limited to a preset type, or any type of event which is generated within a predetermined time before the touch input for detecting widgets associated with an application is applied.

As aforementioned, the controller 180 may detect at least one widget, which is present to correspond to the application as the widget associated with the application.

FIG. 3E is a conceptual view illustrating an embodiment of a user interface for presetting a widget (or at least one widget) associated with an application.

As illustrated in (a) of FIG. 3E, the user may select an icon 370 for setting at least one widget associated with an application in a touching manner.

As illustrated in (b) of FIG. 3E, a list 380 of applications installed in the terminal 100 may be output. Accordingly, the user may touch and select one application within the list 380 of applications.

As illustrated in (c) of FIG. 3E, a list 390 of widgets set in the terminal 100 may be output. Accordingly, the user may select a widget which the user desires to set as being associated with the selected application from the list 390 of widgets.

In detail, when the user touches checkboxes 392 and 394 of widgets which the user desires to select, a tick may be output on each of the checkboxes 392 and 394 for selection.

As a result, when a touch input for outputting a widget associated with an icon of the application selected in (b) of FIG. 3E is applied, the widgets selected in (c) of FIG. 3E may be output.

Meanwhile, the user may edit the widgets which are output in association with the application.

In detail, the controller 180 may control the display unit 151 to delete one of the output widgets associated with the application, in response to a user input.

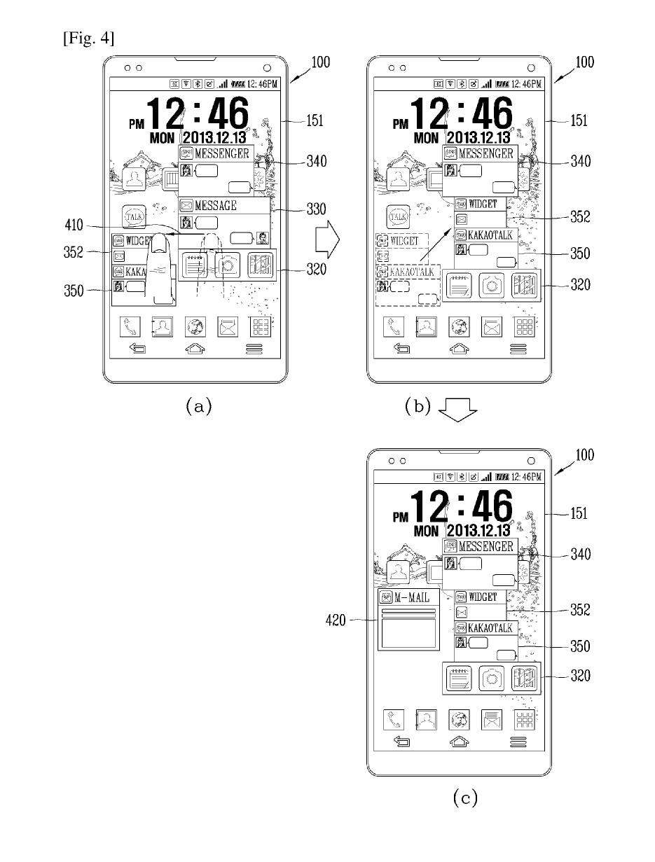

FIG. 4 is a conceptual view illustrating an embodiment of a user interface for deleting a widget output in association with an application.

As illustrated in (a) of FIG. 4, the widgets 350 and 352 corresponding to the first messenger application, the first widget 320 corresponding to the camera application, the second widget 330 corresponding to the second messenger application, and the third widget 340 corresponding to the third messenger application may be output as the widgets associated with the first messenger application.

Here, when the user applies a flicking input 410 to the second widget 330, the second widget 330 may be deleted. Also, an input for deleting the second widget 330 may be implemented in various manners. For example, when the user applies a long touch or a double touch to the second widget 330, the second widget 330 may be deleted.

As illustrated in (b) of FIG. 4, the second widget 330 may be deleted in response to the user's flicking input 410, and the other widgets 320,340, 350 and 352 output may be rearranged.

For example, the widgets 350 and 352 corresponding to the first messenger application may be moved to the position from which the second widget 330 has been deleted and output thereon.

As illustrated in (c) of FIG. 4, in response to the deletion of the second widget 330, a fourth widget 420 associated with the first messenger application may be output.

Here, the fourth widget 420 may be newly detected or set by the user as the widget associated with the first messenger application.

Also, the fourth widget 420 may be output on the region where the deleted second widget 330 has been output or output on a random region.

As another example, in response to a user input for selecting a new widget, the controller 180 may control the display unit 151 to output the newly selected widget in addition to the widgets associated with the application.

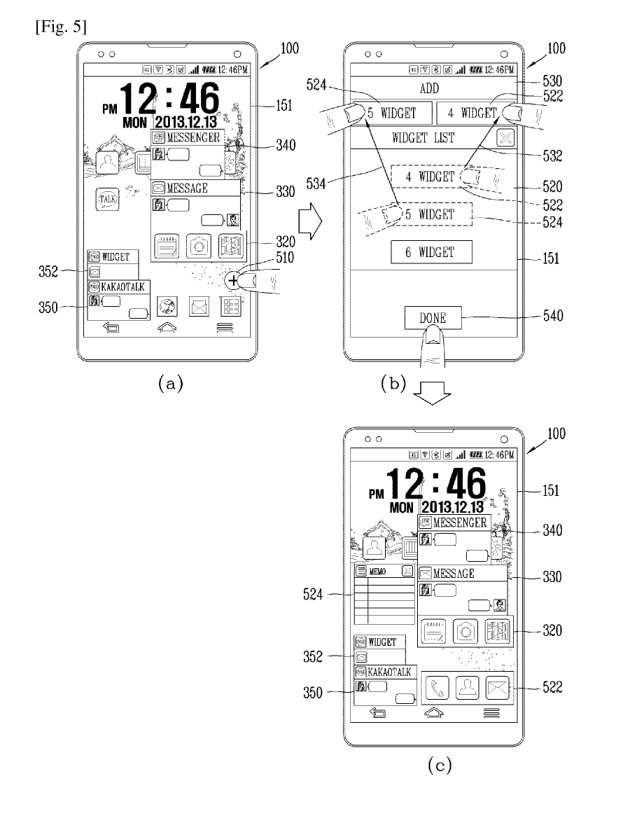

FIG. 5 is a conceptual view illustrating an embodiment of a user interface for adding a widget (or at least one widget) associated with an application.

As illustrated in (a) of FIG. 5, the widgets 350 and 352 corresponding to the first messenger application, the first widget 320 corresponding to the camera application, the second widget 330 corresponding to the second messenger application, and the third widget 340 corresponding to the third messenger application may be output as the widgets associated with the first messenger application.

In addition, an icon 510 corresponding to a widget addition may be output. The user may select the corresponding icon 510 in a touching manner.

As illustrated in (b) of FIG. 5, in response to the selection of the widget add icon 510 by the user, a list 520 of widgets which can be added may be output. Accordingly, the user may select widgets 522 and 524 desiring to add.

In detail, the user may apply an input 532 of dragging the fourth widget 522 to an add icon 530. Similarly, the user may apply an input 534 of dragging the fifth widget 524 toward the add icon 530. Also, the user may touch a complete (done) icon 540 after selecting the widgets 522 and 524 desiring to add.

Here, the widgets output in the widget list 520 may be widgets which are output on the home screen 151 by the user, or widgets which are generated and recommended by the terminal 100.

As illustrated in (c) of FIG. 5, the user-selected widgets 522 and 524 may be added as the widgets associated with the first messenger application.

That is, the widgets 350 and 352 corresponding to the first messenger application, the first widget 320 corresponding to the camera application, the second widget 330 corresponding to the second messenger application, the third widget 340 corresponding to the third messenger application and the added fourth widget 522 and fifth widget 524 may be output as the widgets associated with the first messenger application.

Here, positions of the added fourth and fifth widgets 522 and 524 may be randomly set. Also, sizes of regions on which the widgets 522 and 524 are output may be adjustable by taking into account the sizes of the widgets 350, 352, 320, 330 and 340 which are output on the screen 151 along therewith.

For example, the fourth widget 522 and the fifth widget 524 may be output by being adjusted in size and position, to avoid or minimize an overlap with the regions where the widgets 350 and 352 corresponding to the first messenger application, the first widget 320, the second widget 330 and the third widget 340 are output.

That is, although the widgets have already been output on the home screen 151, the sizes of the regions for outputting the widgets may be newly adjustable, irrespectively of the sizes of the regions where the widgets have already been output on the home screen.

As another example, the controller 180 may control the display unit 151 to set a size of a region for outputting a widget associated with an application, in response to a user input.

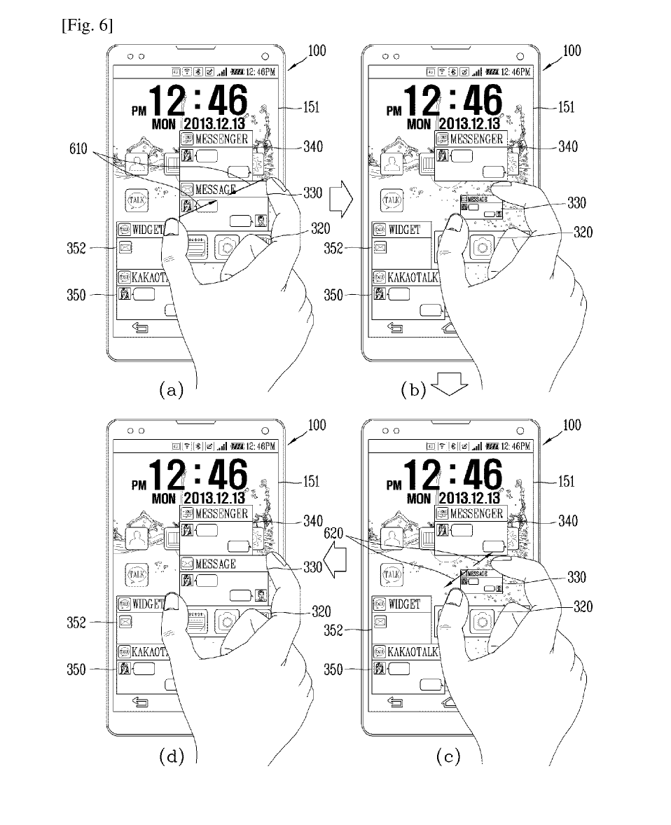

FIG. 6 is a conceptual view illustrating an embodiment of a user interface for adjusting a size of a region for outputting a widget associated with an application.

As illustrated in (a) of FIG. 6, the widgets 350 and 352 corresponding to the first messenger application, the first widget 320 corresponding to the camera application, the second widget 330 corresponding to the second messenger application, and the third widget 340 corresponding to the third messenger application may be output as the widgets associated with the first messenger application.

Here, the user may reduce a size of a region on which the second widget 330 is output. For example, the user may touch the region where the second widget 330 is output simultaneously with two fingers and then apply a pinch-in input 610.

As illustrated in (b) of FIG. 6, the size of the region is reduced in response to the user's pinch-in input 610 applied in (a) of FIG. 6.

That is, when a pinch-in input is applied up to a size of a region to set, the size of the region for outputting a widget is reduced along a user's finger.

As illustrated in (c) of FIG. 6, the user may re-increase the size of the region where the second widget 330 is output. For example, the user may touch the region where the second widget 330 is output simultaneously with two fingers and thereafter apply a pinch-out input 620.

As another example, without taking the finger away after applying the pinch-in input 610 in (b) of FIG. 6, the pinch-out input 620 may be applied again.

As illustrated in (d) of FIG. 6, the size of the region increases in response to the user's pinch-out input 620 applied in (c) of FIG. 6.

That is, when a pinch-out input is applied up to a size of a region to set, the size of the region where a widget is output increases along a user's finger.

As another example, the controller 180 may control the display unit 151 to set a position on which a widget associated with an application is output, in response to a user's input.

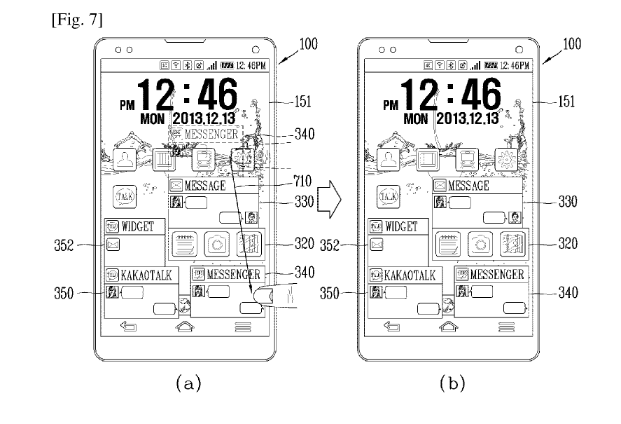

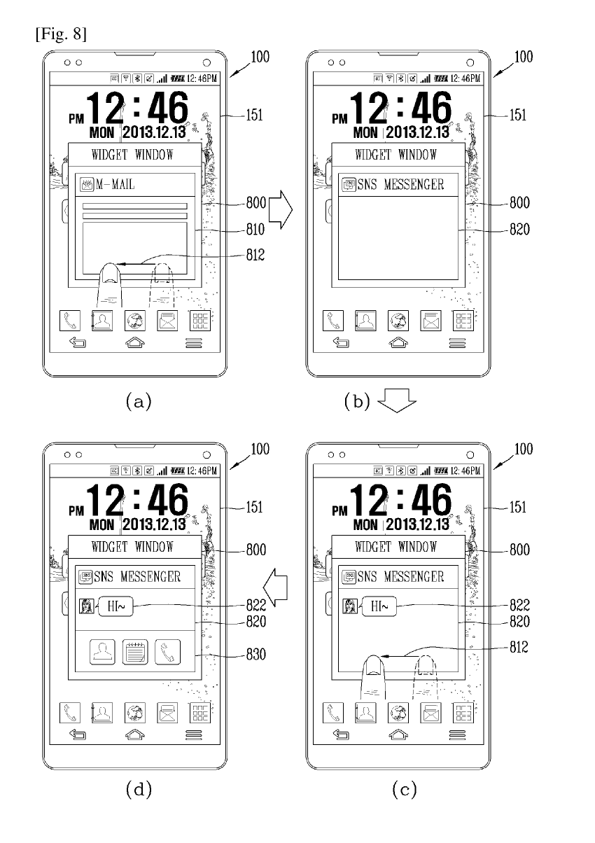

FIG. 7 is a conceptual view illustrating an embodiment of a user interface for rearranging a widget (or at least one widget) associated with an application.

As illustrated in (a) of FIG. 7, the first widget 320 corresponding to the camera application, the second widget 330 corresponding to the second messenger application, and the third widget 340 corresponding to the third messenger application may be output as widgets associated with the first messenger application.

Here, the user may apply an input 710 of dragging the third widget 340 corresponding to the third messenger application to a position desired to move.

As illustrated in (b) of FIG. 7, the third widget 340 may be moved for output in response to the user's drag input 710.

Meanwhile, as aforementioned, the controller 180 may control the display unit 151 to sequentially output widgets associated with a detected application according to a preset criterion.

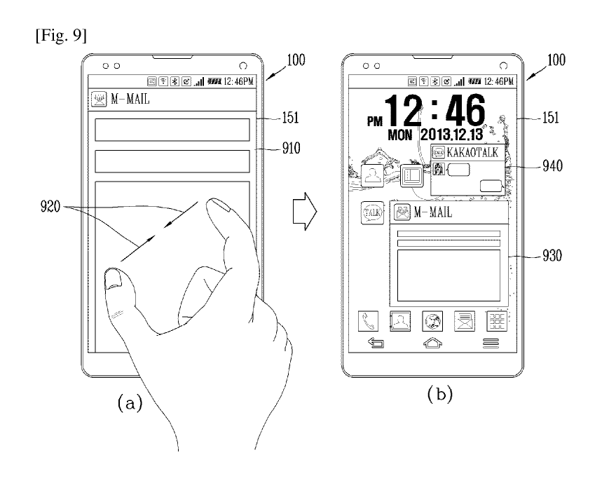

FIG. 8 is a conceptual view illustrating another embodiment of a user interface for sequentially outputting widgets associated with an application.

As illustrated in (a) of FIG. 8, a first widget 810 associated with a first application may be output on a widget window 800. In detail, the widget window 800 may be defined as a region where at least one widget associated with an application is to be output.

Here, the user may apply a flicking input 812 to the widget window 800 with the first widget 810 output thereon.

As illustrated in (b) of FIG. 8, a second widget 820 associated with the first application may be output on the widget window 800, in response to the user's flicking input 812.

As aforementioned, the output order of the widgets may be set by the number of times that the widget is executed before and after activation of the first application, a user-preset order and the like.

For example, the first widget 810 which has been activated the greatest number of times after activation of the first application may be output first, followed by the second widget 820 which has been executed the next greatest number of times.

As illustrated in (c) of FIG. 8, the user may execute an SNS application corresponding to the second widget 820, to write a posting 822 on the SNS. Accordingly, the widget window 800 may output the second widget 820 and the posting 822 as data of the second widget 820. That is, as aforementioned, data which is provided in real time may be output on a widget output.

Also, the user may re-apply the flicking input 812 to the widget window 800 on which the second widget 820 is output.

As illustrated in (d) of FIG. 8, a third widget 830 associated with the first application may be output on the widget window 800, in response to the user's flicking input 812. Also, the previously written posting 822 may also be output together.

That is, the event 822 executed on the previous widget 820 may be output along with the newly-output widget 830. For example, the posting 822 output along with the third widget 830 may disappear after the lapse of a preset time.

Meanwhile, the controller 180 may control the display unit 151 to output widgets associated with an application, in response to a preset touch input applied to an execution screen of the application.

FIG. 9 is a conceptual view illustrating an embodiment of a user interface for shifting an application and a widget.

As illustrated in (a) of FIG. 9, the user may apply a pinch-in input 920 to an execution screen 910 of a first application.

As illustrated in (b) of FIG. 9, in response to the user's pinch-in input 920, the execution screen 910 of the first application may be shifted into a screen on which widgets 930 and 940 associated with the first application are output.

In detail, the first widget 930 corresponding to the first application and the second widget 940 which has been detected by a user's usage pattern, a generated event and the like, may be output.

According to at least one embodiment of the present disclosure, it can be possible to overcome inconvenience in that a desired widget should be searched for by applying a flicking input to home screen pages in order to use one of a plurality of widgets corresponding to a specific application.

Also, according to at least one embodiment of the present disclosure, widgets associated with an application can be integrally managed and an output state of each widget can be edited in an easy manner.

These may result in enhancement of user's convenience.

Further, the present disclosure can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the mobile terminal. Therefore, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A mobile terminal comprising:
a display unit that is configured to output an icon corresponding to an application, and receive a touch input applied to the icon to output a widget associated with the application; and
a controller that is configured to:
detect at least one widget corresponding to the application as the widget associated with the application, in response to the touch input;
detect at least one widget as the widget associated with the application, in response to the touch input, wherein the at least one widget is detected based on an event generated within a preset time before and after activation of the application and an event generated within a preset time before the touch input is applied; and
control the display unit to output the detected at least one widget associated with the application.

2. The mobile terminal of claim 1, wherein the controller detects at least one widget as the widget associated with the application, the at least one widget being detected based on the number of times that a widget is executed within a preset time before and after the activation of the application.

3. The mobile terminal of claim 1, wherein the controller detects a widget preset to correspond to a second application as the widget associated with the application when the second application, different from the application, is executed within a preset time before the touch input is applied.

4. The mobile terminal of claim 1, wherein the controller detects at least one widget preset to correspond to the application as the widget associated with the application.

5. The mobile terminal of claim 1, wherein the controller controls the display unit to sequentially output the detected at least one widget associated with the application according to a preset criterion.

6. The mobile terminal of claim 1, wherein the controller controls the display unit to delete one of the output at least one widget associated with the application, in response to a user's input.

7. The mobile terminal of claim 1, wherein the controller controls the display unit to add a newly-selected widget to the widget associated with the application for output, in response to a user's input for selecting the new widget.

8. The mobile terminal of claim 1, wherein the controller controls the display unit to set a size of a region on which the widget associated with the application is output, in response to a user's input.

9. The mobile terminal of claim 1, wherein the controller controls the display unit to set an output position of the widget associated with the application, in response to a user's input.

10. The mobile terminal of claim 1, wherein the controller controls the display unit to output the widget associated with the application, in response to a preset touch input applied to an execution screen of the application.

11. A control method for a mobile terminal, the method comprising:
(a) outputting an icon corresponding to an application;
(b) receiving a touch input applied to the icon to output a widget associated with the application;
(c1) detecting at least one widget corresponding to the application as the widget associated with the application, in response to the touch input;
(c2) detecting at least one widget as the widget associated with the application, in response to the touch input, wherein the at least one widget is detected based on an event generated within a preset time before and after activation of the application and an event generated within a preset time before the touch input is applied; and
(d) outputting the detected at least one widget associated with the application.

12. The method of claim 11, wherein the step (c2) comprises:
detecting at least one widget as the widget associated with the application, the at least one widget being detected based on the number of times that a widget is executed within a preset time before and after the activation of the application.

13. The method of claim 11, wherein the step (c2) comprises:
detecting a widget preset to correspond to a second application as the widget associated with the application when the second application, different from the application, is executed within a preset time before the touch input is applied.

14. The method of claim 11, wherein the step (c2) comprises:
detecting at least one widget preset to correspond to the application as the widget associated with the application.

15. The method of claim 11, wherein the step (d) comprises:
sequentially outputting the detected at least one widget associated with the application according to a preset criterion.

16. The method of claim 11, wherein the step (d) comprises:
deleting one of the output at least one widget associated with the application, in response to a user's input.

17. The method of claim 11, wherein the step (d) comprises:
adding a newly-selected widget to the widget associated with the application for output, in response to a user's input for selecting the new widget.

18. The method of claim 11, wherein the step (d) comprises:
setting a size of a region on which the widget associated with the application is output, in response to a user's input.

19. The method of claim 11, wherein the step (d) comprises:
setting an output position of the widget associated with the application, in response to a user's input.

20. The method of claim 11, wherein the step (d) comprises:
outputting the widget associated with the application, in response to a preset touch input applied to an execution screen of the application.
